(19) United States
(12) Patent Application Publication
(10) Pub. No.: US 2025/0094326 A1
(43) Pub. Date: Mar. 20, 2025

(54) GENERATING A TEST SUITE FOR AN APPLICATION PROGRAMMING INTERFACE

(71) Applicant: Capital One Services, LLC, McLean, VA (US)

(72) Inventors: Veerapu NAGARJUN, Bengaluru (IN); Lavanya RAJA, Frisco, TX (US); Puneet GOYAL, Bangalore (IN); Srinivas KUMAR, Chennai (IN); Chandana Bhavani YERRABATHINI, AndhraPradesh (IN)

(21) Appl. No.: 18/470,675

(22) Filed: Sep. 20, 2023

(51) Int. Cl. G06F 11/36

(52) U.S. Cl. CPC G06F 11/3684; G06F 11/3676

(57) ABSTRACT

In some implementations, a system may obtain a specification associated with an application programming interface (API). The system may generate a test object based on the specification associated with the API. The test object may include information associated with a set of test cases for the API. The system may identify a framework associated with a test suite to be generated for the API. The system may generate the test suite for the API based on the test object and the identified framework. The system may provide information associated with the test suite for the API.

### BACKGROUND

An application programming interface (API) is software interface that enables communication between different applications according to a set of defined rules. In general, an API acts as an intermediary layer that processes data transfers between different systems. For example, an API may act as a bridge to take a request from a first application, translate the request into a format compatible with a second application, and deliver the request to the second application. An API may use various routines, tools, and/or protocols to specify how different software components and/or applications are to function together.

API testing is a type of software testing that analyzes an API to determine whether the API achieves expected functionality, security, performance, and/or reliability. An API test is generally performed by making a request to one or more API endpoints and comparing a responses with an expected result.

### SUMMARY

Some implementations described herein relate to a system for generating a test suite for an application programming interface (API). The system may include one or more memories and one or more processors communicatively coupled to the one or more memories. The one or more processors may be configured to obtain a specification associated with an API. The one or more processors may be configured to generate a test object based on the specification associated with the API, wherein the test object comprises information associated with a set of test cases for the API. The one or more processors may be configured to identify a framework associated with a test suite to be generated for the API. The one or more processors may be configured to generate the test suite for the API based on the test object and the identified framework. The one or more processors may be configured to provide information associated with the test suite for the API.

Some implementations described herein relate to a method for generating a test suite for an API. The method may include generating, by a system, an object based on a specification associated with the API, wherein the object includes information associated with at least one test case associated with the API. The method may include identifying, by the system, a framework to be applied to the object in association with generating a test suite for the API. The method may include applying, by the system, the framework to the object to generate the test suite for the API. The method may include providing, by the system, information associated with the test suite.

Some implementations described herein relate to a non-transitory computer-readable medium that stores a set of instructions. The set of instructions, when executed by one or more processors of a system, may cause the system to obtain a specification associated with an API. The set of instructions, when executed by one or more processors of the system, may cause the system to identify a plurality of specification attributes based on the specification. The set of instructions, when executed by one or more processors of the system, may cause the system to generate a test object based on the plurality of specification attributes, wherein the test object includes information associated with a plurality of test cases associated with testing the API. The set of instructions, when executed by one or more processors of the system, may cause the system to generate a test suite for the API based on the test object and a particular framework of a plurality of different frameworks. The set of instructions, when executed by one or more processors of the system, may cause the system to provide information associated with the test suite.

### BRIEF DESCRIPTION OF THE DRAWINGS

FIGS. 1A-1I are diagrams of an example associated with generating a test suite for an application programming interface (API), in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with generating a test suite for an API, in accordance with some embodiments of the present disclosure.

FIG. 4 is a flowchart of an example process associated with generating a test suite for an API, in accordance with some embodiments of the present disclosure.

### DETAILED DESCRIPTION

The following detailed description of example implementations refers to the accompanying drawings. The same reference numbers in different drawings may identify the same or similar elements.

As the number of application programming interfaces (APIs) in use increases, so too does the need to enable API testing to ensure expected functionality, security, performance, and/or reliability of a given API. Conventionally, a user (e.g., a software developer) manually writes API test cases (e.g., in plain English) after review of an API specification. Next, the user sets up a specific (desired) test framework, and then manually codes the test cases using random test data. Any updates to the API specification require manual revision of the code written for the API test cases.

One challenge to providing adequate API testing in the face of the proliferation of API usage is that, as the number of APIs increases, API testing is often overlooked due to a variety of factors, such as the cumbersome nature of providing adequate API testing for a given API, an amount of time required to perform adequate API testing for a given API, or external deadlines with respect to development of the given API that result in time constraints that do not allow for adequate API testing. Therefore, many APIs have relatively few tests (e.g., a single test) written, meaning that in many cases functionality, security, performance, and/or reliability of the API are not adequately tested. Another challenge to providing adequate API testing is a lack of a standard benchmark for API test coverage. The lack of a standard benchmark means that adequacy of API testing may differ among APIs, even APIs associated with the same entity (e.g., a particular organization). As a result of these challenges, testing for a given API, or for a group of APIs, may be insufficient, meaning that functionality, security, performance and/or reliability of a given API may suffer.

Some implementations described herein enable test suite generation for an API. In some implementations, a test suite generation system may obtain a specification associated with an API. The test suite generation system may generate a test object based on the specification associated with the API. The test object includes information associated with a set of test cases for the API. The test suite generation system may then identify a framework associated with a test suite to be generated for the API, and may generate the test suite for the API based on the test object and the identified framework. The test suite generation system may then provide information associated with the test suite for the API (e.g., to enable API testing for the API).

In some implementations, the techniques and apparatuses described herein improve API functionality, security, performance, and/or reliability (e.g., for a given API or overall for a group of APIs). For example, the techniques and apparatuses described herein enable automated generation of a test suite using a test object that is generated based on an API specification, and according to a desired framework. Here the automated generation of the test suite facilitates thorough, reliable, and relevant API testing, thereby improving functionality, security, performance and/or reliability of the API.

Further, the techniques and apparatuses described herein generate and utilize a test object in association with generating a test suite for an API. In some implementations, the test object is framework agnostic, meaning that the test object can be used to generate a test suite for any API test framework. In this way, the test object supports test suite generation for different frameworks, thereby providing a flexibility with respect to test suite generation and customization of test suite generation without degrading adequacy of API testing.

Additionally, the techniques and apparatuses described herein for test suite generation described improve efficiency with respect to API testing. For example, a test suite generated according to the techniques and apparatuses described herein enable “one-shot” API testing, meaning that an API endpoint needs to be contacted only once (rather than multiple times, as is the case for conventional API testing). In this way, testing efficiency is increased and resource usage at the API endpoint is reduced. Additional details are provided below.

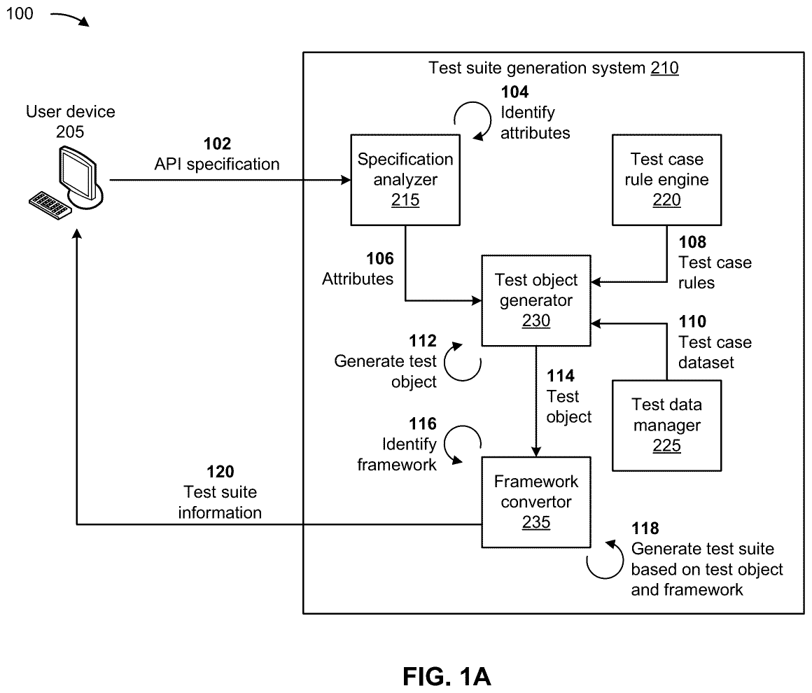

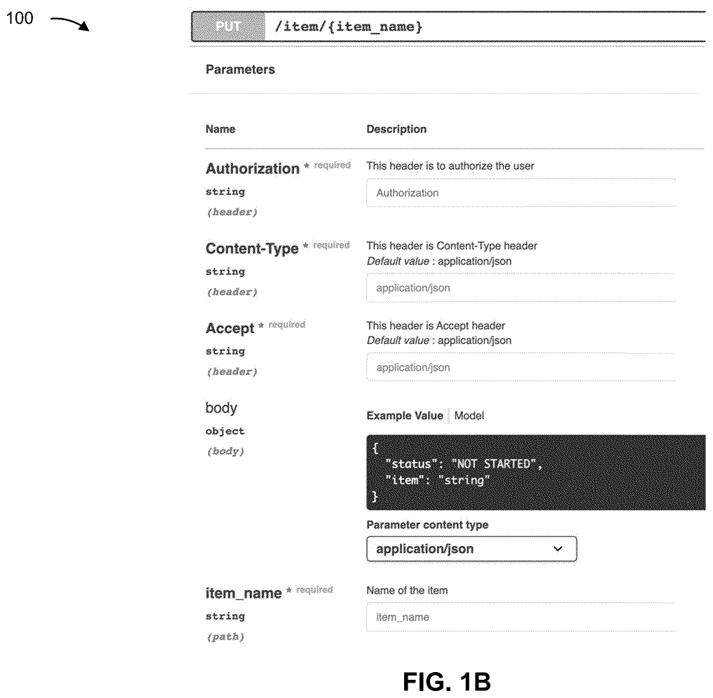

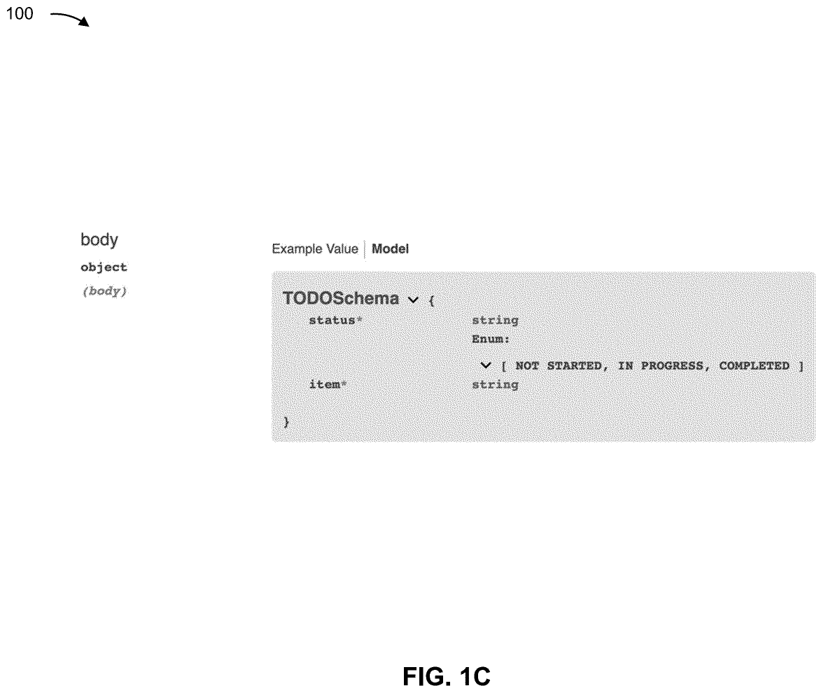

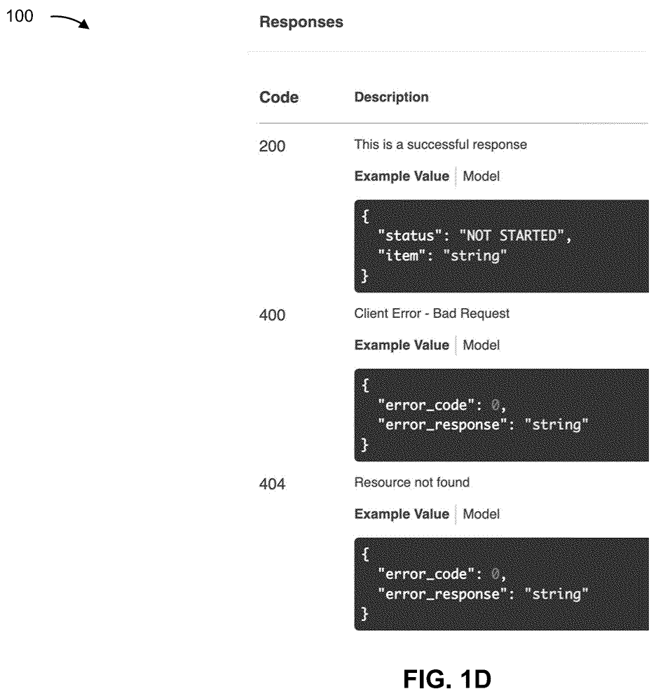

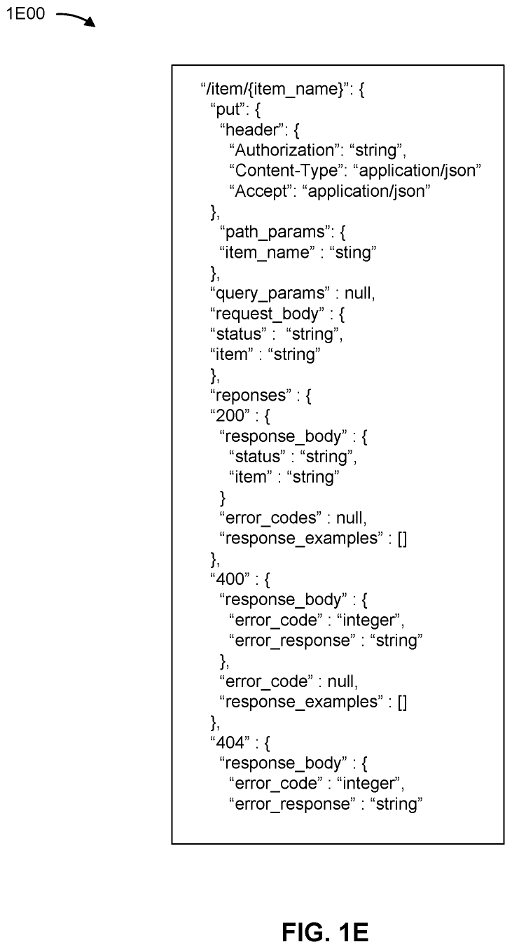

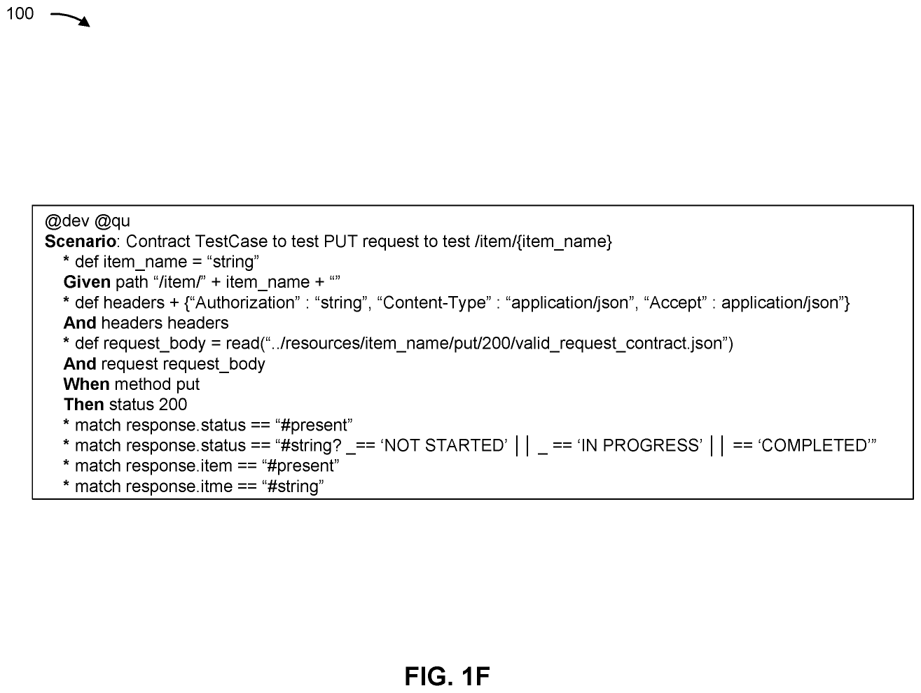

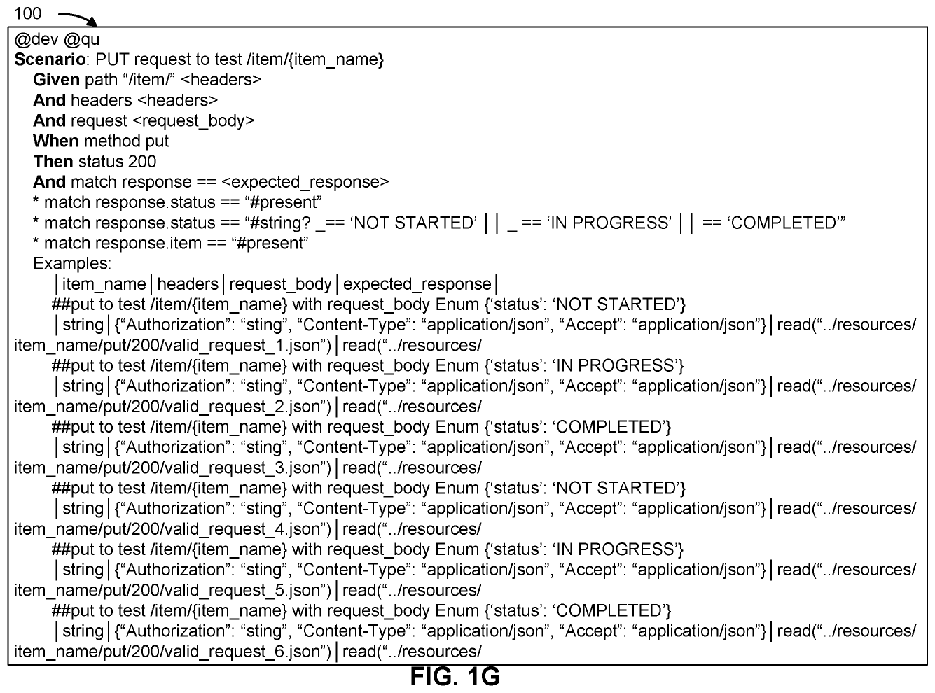

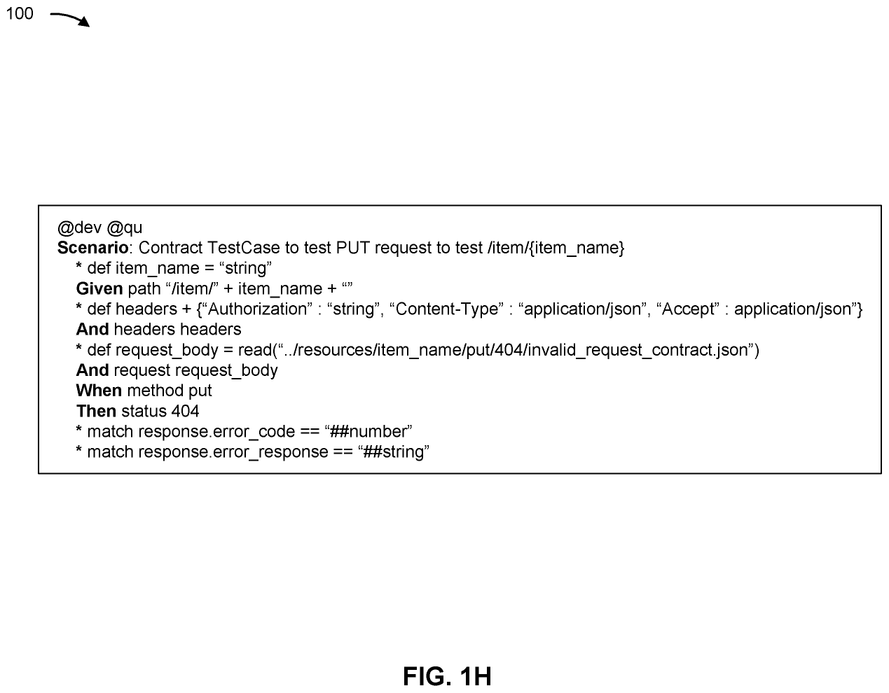

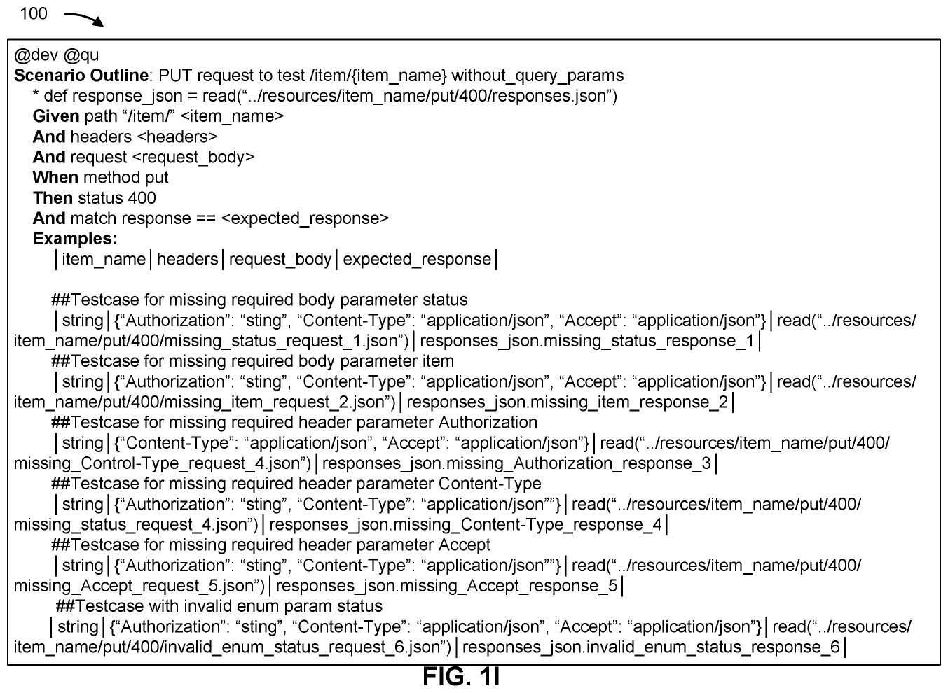

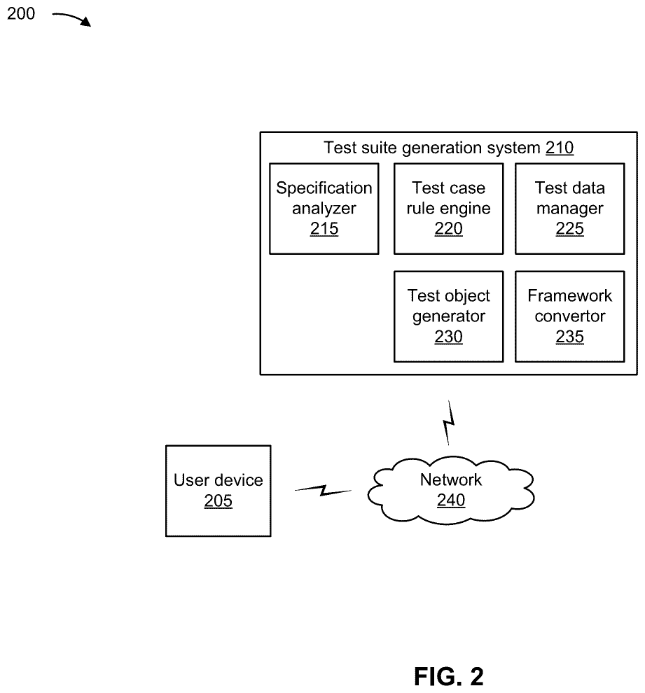

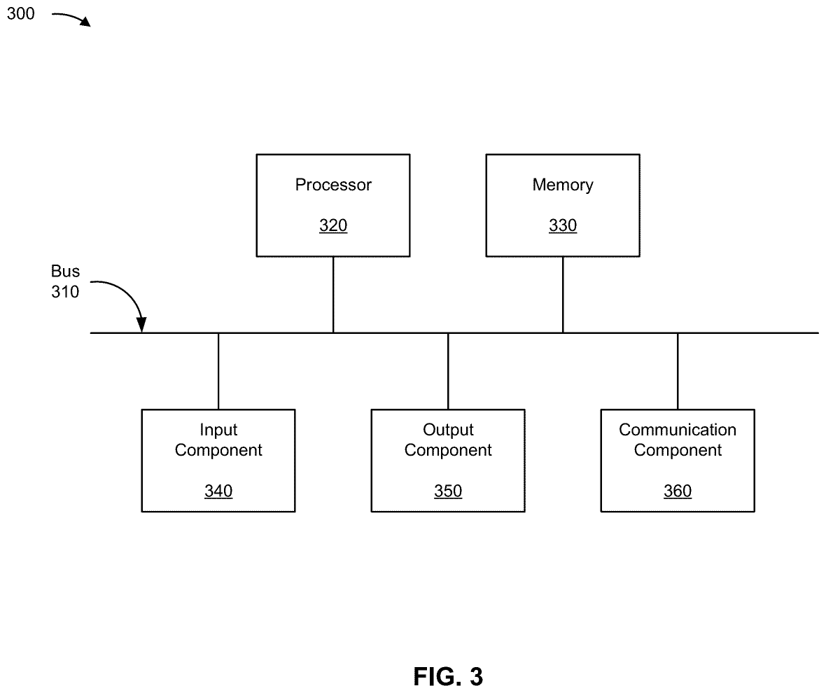

FIGS. 1A-1I are diagrams of an example 100 associated with generating a test suite for an API. As shown in FIGS. 1A-1I, example 100 includes a user device 205 and a test suite generation system 210 including a specification analyzer 215, a test case rule engine 220, a test data manager 225, a test object generator 230, and a framework convertor 235. These devices are described in more detail in connection with FIGS. 2 and 3.

As shown at reference 102, the specification analyzer 215 may obtain a specification associated with the API for which a test suite is to be generated. A specification associated with an API (herein referred to as an API specification) includes, in general, information that defines how to communicate with the API, what information can be requested from the API, and what information can be returned by the API. More specifically, the API specification may include information associated with one or more objects, such as an information object, a server object, one or more path objects, one or more component objects, one or more security objects, or one or more tag objects, among other examples.

A path object includes information associated with an API endpoint. For each endpoint, the API specification may define one or more hypertext transfer protocol (HTTP) methods and potential responses, along with other optional parameters. An HTTP method may be referred to as an operation, and an endpoint may be referred to as a path. Some examples of operations that may be described in the API specification include, GET, PUT, POST, DELETE, OPTIONS, HEAD, PATCH, and TRACE. A set of parameters can be defined for within an operation. The set of parameters may define, for example, how information is to be provided in an API request using the corresponding path. The API specification may define how the operation accepts the set of parameters and what form the set of parameters should take. Additionally, the API specification may describe requirements for a request body associated with sending information to the API server. Further, the API specification may define a form for a response to an API request, such as information associated with a response body, a status code, or one or more other items of information. In some implementations, the API specification may include one or more other items of information, such as example requests, example responses, example data, or another type of information. In some implementations, the API specification may be written according to a particular API specification language, such as OpenAPI (formerly Swagger).

In some implementations, as indicated in FIG. 1A, the specification analyzer 215 may receive the API specification from the user device 205. For example, a user (e.g., a software engineer) may upload the API specification to the test suite generation system 210 via the user device 205 such that the API specification is received at the specification analyzer 215.

As shown at reference 104, the specification analyzer 215 may identify a plurality of specification attributes based on the API specification. The plurality of specification attributes comprises one or more items of information, properties, characteristics, or the like, described in the API and based on which a test object can be generated, as described herein. Put another way, the plurality of specification attributes may include one or more items of information that serve as a basis for generating a test object that describes one or more test cases associated with testing the API. The plurality of specification attributes may include, for example, information associated with one or more paths (endpoints), such as information associated with one or more operations associated with the one or more paths and/or information associated with one or more sets of parameters associated with the one or more operations. As another example, the plurality of specification attributes may include information associated with one or more examples requests included in the API specification, one or more example responses included in the API specification, and/or example data included in the API specification.

In some implementations, to identify the plurality of specification attributes, the specification analyzer 215 may include an API specification parsing model. The API specification parsing model may be a model configured to process an API specification to identify a plurality of attributes based on which a test object can be generated. In some implementations, the API specification parsing model may be configured or trained using one or more artificial intelligence (AI) techniques. The one or more AI techniques may include, for example, machine learning, a convolutional neural network, deep learning, language processing, or the like. For example, in some implementations, the one or more AI techniques may enable the specification analyzer 215 to receive the API specification as input and provide information that identifies a plurality of specification attributes as an output. In some implementations, the plurality of specification attributes may comprise a data object that includes a group of attributes described in the API specification. As described below, this specification data object may be used along with one or more other items of information to generate a test object (e.g., a data object that defines one or more test cases associated with testing the API).

As shown at reference 106, the specification analyzer 215 may provide, and the test object generator 230 may receive, information associated with the plurality of specification attributes identified by the specification analyzer 215.

Further, as shown at reference 108, the test object generator 230 may determine a set of test case rules. For example, the test object generator 230 may receive information associated with the set of test case rules from the test case rule engine 220. The set of test case rules comprises information that defines a manner in which a particular aspect of the API (e.g., as defined by one or more attributes) is to be tested. For example, a test case rule may indicate one or more scenarios that define a manner in which a particular response type (e.g., response 200, response 400, or the like) defined in the API specification (e.g., by the plurality of API attributes) is to be tested. Here, each scenario associated with the test case rule may correspond to a different outcome associated with the particular response type that needs to be tested (e.g., such that the test case rule defines scenarios designed to test multiple or all possible outcomes associated with the particular response type).

In some implementations, the set of test case rules may be determined based on the plurality of specification attributes. For example, the test case rule engine 220 may store or have access to a database that maintains test case rules, and may be configured with a test case rule model configured to process information associated with the plurality of specification attributes to identify a set of test case rules. In some implementations, the test case rule model may be configured or trained using one or more AI techniques. The one or more AI techniques may include, for example, machine learning, a convolutional neural network, deep learning, language processing, or the like. For example, in some implementations, the one or more AI techniques may enable the test case rule engine 220 to receive information associated with the plurality of specification attributes as input and provide information associated with a set of test case rules as an output. Here, the set of test case rules may include one or more test case rules that the test case rule model identifies as being applicable to the plurality of specification attributes identified based on the API specification.

Further, as shown at reference 110, the test object generator 230 may determine a test case dataset. For example, the test object generator 230 may receive one or more items of test data from the test data manager 225. The test case dataset is comprises data to be used for performing testing of the API. For example, the test case dataset may include one or more values for one or more variables data used during execution of a test case.

In some implementations, one or more items of data in the test case dataset can be determined based on the specification associated with the API. That is, in some implementations, the test object generator 230 may determine one or more items of data from the plurality of specification attributes. For example, the plurality of specification attributes may include one or more items test data identified by the specification analyzer 215 based on the parsing of the API specification.

Additionally, or alternatively, one or more items of data in the test case dataset can be determined based on the data traffic associated with the API. For example, the test data manager 225 may have access to data traffic (e.g., incoming data traffic and/or outgoing data traffic) associated with the API. In such a scenario, the test data manager 225 may be capable of analyzing the data traffic to identify one or more items of data that are received by or transmitted by the API (e.g., in an API request, in an API response, or the like). Here, the test data manager 225 may store (e.g., copy) the one or more items of data in a test case dataset managed by the test data manager 225. In this way, the test data manager 225 may identify one or more items of realistic data that for use in association with API testing (e.g., rather than randomly generated data), which may improve performance of API testing by enabling comparatively more realistic testing (e.g., as compared to testing using randomly generated test data).

Additionally, or alternatively, one or more items of data in the test case dataset can be determined based on user input. For example, the user may provide, via the user device 205, one or more items of test data to be used for testing the API, and the test object generator 230 may store the one or more items of test data accordingly.

As shown at reference 112, the test object generator 230 may generate a test object based on the API specification. In some implementations, the test object includes information associated with a set of test cases for the API. Thus, in some implementations, to generate the test object, the test object generator 230 may determine the set of test cases for the API. The set of test cases comprises information that defines one or more cases based on which API testing can be performed, with a given test cases comprising information associated with a particular testing scenario. In some implementations, the test object is a data object that defines includes information associated with the set of test cases. In some implementations, the set of test cases includes at least one test case associated with an API request (e.g., the set of test cases may include a request test case). Additionally, or alternatively, the set of test cases may include at least one test case associated with an API response (e.g., the set of test cases may include a response test case).

In some implementations, the test object is framework agnostic, meaning that the test object is not associated with a particular framework. Thus, the test object can be used to generate a test suite for any API test framework. In this way, the test object supports test suite generation for different frameworks, thereby providing a flexibility with respect to test suite generation and customization of test suite generation without degrading adequacy of API testing.

In some implementations, the test object generator 230 may generate the test object based on the plurality of specification attributes, the set of test case rules, and the test case dataset. For example, the test object generator 230 may in some implementations determine the information associated with the set of test cases defined by the test object based on the plurality of specification attributes, the set of test case rules, and/or the test case dataset. For example, the test object generator 230 may be configured with a test object model configured to process the plurality of specification attributes, the set of test case rules, and the test case dataset to determine the set of test cases and generate thew test object. In some implementations, the test object model may be configured or trained using one or more AI techniques. The one or more AI techniques may include, for example, machine learning, a convolutional neural network, deep learning, language processing, or the like. For example, in some implementations, the one or more AI techniques may enable the test object generator 230 to receive information associated with the plurality of specification attributes, the set of test case rules, and the test case dataset as input and provide the test object including the set of teste cases as an output.

As shown at reference 114, the test object generator 230 may provide, and the framework convertor 235 may receive, the test object including associated with the set of test cases for the API.

As shown at reference 116, the framework convertor 235 may identify a framework associated with a test suite to be generated for the API. The framework associated with the test suite includes a structure or guideline according to which (e.g., automated) API testing is to be performed. Examples of API testing frameworks include Karate, SoapUI, Postman, REST-Assured, among others. In some implementations, the framework may be a user-defined or user-customized framework (e.g., based on input provided via the user device 205).

In some implementations, the framework convertor 235 may identify the framework associated with the test suite based on user input. For example, the user may provide, via the user device 205, input that indicates a framework to be used for generation of the test suite. Additionally, or alternatively, the framework convertor 235 may identify the framework as a default framework configured on the framework convertor 235 (e.g., when the user does not specify the framework).

As shown at reference 118, the framework convertor 235 may generate the test suite for the API based on the test object and the identified framework. For example, the framework convertor 235 may apply the framework to the test object to create the test suite. Put another way, the framework convertor 235 may convert the test object to a test suite, where the test suite incorporates properties and characteristics associated with the framework. Thus, the framework convertor 235 may in some implementations apply properties and characteristics associated with the framework to the framework agnostic test object (e.g., such that the framework-agnostic test object is “converted” to a test suite that incorporates the properties and characteristics of the framework).

As shown at reference 120, the framework convertor 235 may provide information associated with the test suite for the API. For example, the framework convertor 235 may provide the information associated with the test suite for the API to the user device 205 (e.g., to enable the user device 205 to perform automated API testing using the test suite).

In this way, the test suite generation system 210 may generate a test suite using a framework agnostic test object (e.g., generated based at least in part on an API specification), and then apply a desired framework to create a test suite that can utilized for API testing. Here the automated generation of the test suite facilitates thorough, reliable, and relevant API testing, thereby improving functionality, security, performance and/or reliability of the API. Further, the framework-agnostic nature of the test object supports test suite generation for different frameworks, thereby providing a flexibility with respect to test suite generation and customization of test suite generation without degrading adequacy of API testing. Further, a test suite generated by the test suite generation system 210 enables “one-shot” API testing, meaning that an API endpoint needs to be contacted only once (rather than multiple times, as is the case for conventional API testing). In this way, testing efficiency is increased and resource usage at the API endpoint is reduced.

FIGS. 1B-1I are provide an illustrative example of test suite generation as described herein. FIGS. 1B-1D are examples associated with an API specification that can be obtained by the test suite generation system 210. As illustrated in FIG. 1B, the API specification may describe a PUT endpoint associated with updating a status of an item. As shown, the PUT endpoint may be defined to take three headers (Authorization, Content-Type, and Accept), and an item and a status as a request body parameters to update the status of the item. As shown in FIG. 1C, the API specification may specify that the status parameter takes in three enumeration (enum) values—NOT STARTED, IN PROGRESS, and COMPLETED. FIG. 1D illustrates responses and response codes described in the API specification. In some implementations, the test suite generation system 210 parses the API specification to determine a plurality of specification attributes associated with the API specification.

FIG. 1E illustrates an example associated with a test object (e.g., a json object) generated based on the example API specification illustrated in FIGS. 1B-1D. As shown in FIG. 1E, based on the plurality of specification attributes as described in the API specification (e.g., and based on a set of test case rules and/or a test case dataset), the test suite generation system 210 may generate a test object having a path “/item/{item_name}” with a PUT request method. As shown, the test object describes “headers”, “path_params”, “query_params”, “request_body” and “response_body” with multiple response codes as specified in the example API specification described above. Notably, the test object illustrated in FIG. 1E is framework agnostic, meaning that the test object can be used in association with generating a test suite for any framework.

FIGS. 1F-1I illustrate example of test cases included in a test suite generated based on the test object illustrated in FIG. 1E. That is, FIG. 1F-11 illustrate example test cases for a particular framework (e.g., after the framework convertor 235 applies the framework to the test object).

FIG. 1F illustrates an example of a test case that can be used to validate data types and associated constraints as specified in the API specification. FIG. 1G illustrates an example of functional teste cases that cover a variety of valid responses (e.g., various responses 200). Notably, as the status parameter has three different enum values, the test suite is generated so as to include test cases associated with test all three possible enum values. Here, the test suite generation system 210 may extract all the valid values from request and responses and then determine test cases from the request and response point of view. As further shown, assertions for the required parameters and enums are provided.

FIG. 1H illustrates an example of a test case to validate a contract for 400 response codes. In this test case, contract validation for bad request (e.g., 4xx cases) are tested. are bad requests. FIG. 1I illustrates response 400 test cases with invalid request data. As shown, the test suite generation system 210 generates the test cases by missing a required parameter or by providing invalid data for parameters indicated in the API specification. In some implementations, the test suite may include one or more objects (e.g., one or more json files) associated with providing data inputs for test cases in the test suite.

As indicated above, FIGS. 1A-1I are provided as an example. Other examples may differ from what is described with regard to FIGS. 1A-1I.

FIG. 2 is a diagram of an example environment 200 in which systems and/or methods described herein may be implemented. As shown in FIG. 2, environment 200 may include a user device 205, a test suite generation system 210 (including a specification analyzer 215, a test case rule engine 220, a test data manager 225, a test object generator 230, and a framework convertor 235), and a network 240. Devices of environment 200 may interconnect via wired connections, wireless connections, or a combination of wired and wireless connections.

The user device 205 may include one or more devices capable of receiving, generating, storing, processing, and/or providing information associated with generating a test suite for an API, as described elsewhere herein. The user device 205 may include a communication device and/or a computing device. For example, the user device 205 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The test suite generation system 210 may include one or more devices capable of receiving, generating, storing, processing, providing, and/or routing information associated with generating a test suite for an API, as described elsewhere herein. The test suite generation system 210 may include a communication device and/or a computing device. For example, the test suite generation system 210 may include a server, such as an application server, a client server, a web server, a database server, a host server, a proxy server, a virtual server (e.g., executing on computing hardware), or a server in a cloud computing system. In some implementations, the test suite generation system 210 may include computing hardware used in a cloud computing environment. As shown, the test suite generation system 210 may include a specification analyzer 215, a test case rule engine 220, a test data manager 225, a test object generator 230, and a framework convertor 235. These components of the test suite generation system 210 may be configured to receive, generate, store, process, provide, and/or route information associated with generating a test suite for an API, as described elsewhere herein.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with generating a test suite for an API. The device 300 may correspond to a user device 205, a test suite generation system 210, and/or one or more components of the test suite generation system 210 (e.g., a specification analyzer 215, a test case rule engine 220, a test data manager 225, a test object generator 230, a framework convertor 235, or the like). In some implementations, a user device 205, a test suite generation system 210, and/or one or more components of the test suite generation system 210 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

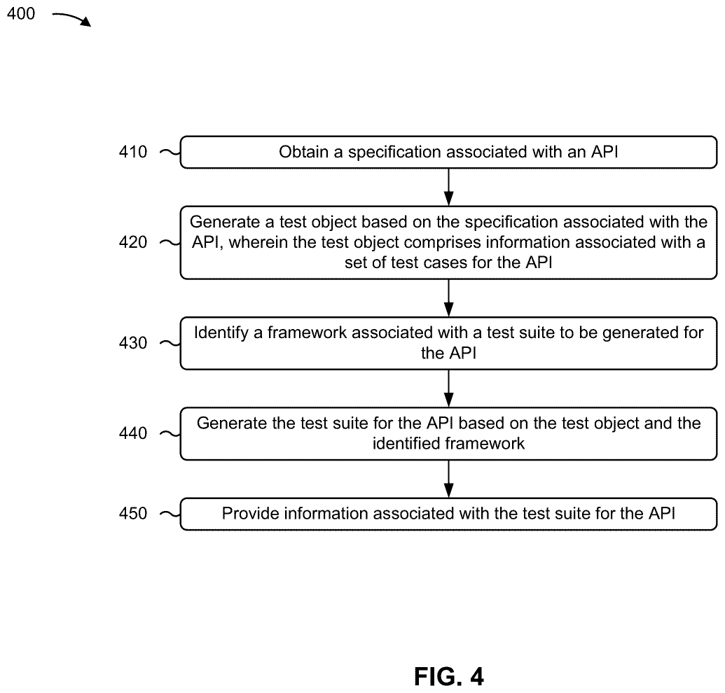

FIG. 4 is a flowchart of an example process 400 associated with generating a test suite for an API. In some implementations, one or more process blocks of FIG. 4 may be performed by the test suite generation system 210. In some implementations, one or more process blocks of FIG. 4 may be performed by another device or a group of devices separate from or including the test suite generation system 210, such as the user device 205. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining a specification associated with an API (block 410). For example, the test suite generation system 210 (e.g., using the specification analyzer 215, using processor 320 and/or memory 330) may obtain a specification associated with an API, as described above in connection with reference number 102 of FIG. 1A.

As further shown in FIG. 4, process 400 may include generating a test object based on the specification associated with the API, wherein the test object comprises information associated with a set of test cases for the API (block 420). For example, the test suite generation system 210 (e.g., using the test object generator 230, using processor 320 and/or memory 330) may generate a test object based on the specification associated with the API, wherein the test object comprises information associated with a set of test cases for the API, as described above in connection with reference number 112 of FIG. 1A.

As further shown in FIG. 4, process 400 may include identifying a framework associated with a test suite to be generated for the API (block 430). For example, the test suite generation system 210 (e.g., using the framework convertor 235, using processor 320 and/or memory 330) may identify a framework associated with a test suite to be generated for the API, as described above in connection with reference number 114 of FIG. 1A.

As further shown in FIG. 4, process 400 may include generating the test suite for the API based on the test object and the identified framework (block 440). For example, the test suite generation system 210 (e.g., using the framework convertor 235, using processor 320 and/or memory 330) may generate the test suite for the API based on the test object and the identified framework, as described above in connection with reference number 116 of FIG. 1A.

As further shown in FIG. 4, process 400 may include providing information associated with the test suite for the API (block 450). For example, the test suite generation system 210 (e.g., using the framework convertor 235, using processor 320 and/or memory 330) may provide information associated with the test suite for the API, as described above in connection with reference number 118 of FIG. 1A.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1I. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for generating a test suite for an application programming interface (API), the system comprising:
one or more memories; and
one or more processors, communicatively coupled to the one or more memories, configured to:
obtain a specification associated with an API;
generate a test object based on the specification associated with the API, wherein the test object comprises information associated with a set of test cases for the API;
identify a framework associated with a test suite to be generated for the API;
generate the test suite for the API based on the test object and the identified framework; and
provide information associated with the test suite for the API.

2. The system of claim 1, wherein the one or more processors, to generate the test object, are configured to:
identify a plurality of specification attributes based on the specification associated with the API, and
generate the test object based on the plurality of specification attributes.

3. The system of claim 1, wherein the one or more processors, to generate the test object, are configured to:
identify a set of test case rules, and
determine the information associated with the set of test cases based on the set of test case rules.

4. The system of claim 1, wherein the one or more processors, to generate the test object, are configured to:
determine a test case dataset, and
determine the information associated with the set of test cases based on the test case dataset.

5. The system of claim 4, wherein the one or more processors, to determine the test case dataset, are configured to determine the test case dataset based on at least one of the specification associated with the API, data traffic associated with the API, or user input.

6. The system of claim 1, wherein the test object is framework agnostic.

7. The system of claim 1, wherein the set of test cases includes at least one test case associated with an API response.

8. A method for generating a test suite for an application programming interface (API), comprising:
generating, by a system, an object based on a specification associated with the API, wherein the object includes information associated with at least one test case associated with the API;
identifying, by the system, a framework to be applied to the object in association with generating a test suite for the API;
applying, by the system, the framework to the object to generate the test suite for the API; and
providing, by the system, information associated with the test suite.

9. The method of claim 8, wherein generating the object comprises:
analyzing the specification to identify a plurality of specification attributes, and
generating the object based on the plurality of specification attributes.

10. The method of claim 8, wherein generating the object comprises determining the information associated with the at least one test case based on a set of test case rules.

11. The method of claim 8, wherein generating the object comprises determining the information associated with the at least one test case based on a test case dataset.

12. The method of claim 11, wherein the test case dataset is based on at least one of the specification, data traffic associated with the API, or user input.

13. The method of claim 8, wherein the object is not specific to the framework.

14. The method of claim 8, wherein the at least one test case includes a test case for an API response.

15. A non-transitory computer-readable medium storing a set of instructions, the set of instructions comprising:
one or more instructions that, when executed by one or more processors of a system, cause the system to:
obtain a specification associated with an application programming interface (API);
identify a plurality of specification attributes based on the specification;
generate a test object based on the plurality of specification attributes,
wherein the test object includes information associated with a plurality of test cases associated with testing the API;
generate a test suite for the API based on the test object and a particular framework of a plurality of different frameworks; and
provide information associated with the test suite.

16. The non-transitory computer-readable medium of claim 15, wherein the one or more instructions, that cause the system to generate the test object, cause the system to:
identify a set of test case rules, and
determine the information associated with the plurality of test cases based on the set of test case rules.

17. The non-transitory computer-readable medium of claim 15, wherein the one or more instructions, that cause the system to generate the test object, cause the system to:
determine a test case dataset, and
determine the information associated with the plurality of test cases based on the test case dataset.

18. The non-transitory computer-readable medium of claim 17, wherein the one or more instructions, that cause the system to determine the test case dataset, cause the system to determine the test case dataset based on at least one of the specification, data traffic associated with the API, or user input.

19. The non-transitory computer-readable medium of claim 15, wherein the test object is compatible with each framework in the plurality of different frameworks.

20. The non-transitory computer-readable medium of claim 15, wherein the plurality of test cases includes a test case associated with an API response.
